(19) United States
(12) Patent Application Publication
(10) Pub. No.: US 2007/0081277 A1
(43) Pub. Date: Apr. 12, 2007

(54) Method and apparatus for reducing shield noise in magnetoresistive sensors

(75) Inventors: Liesl Folks, Campbell, CA (US); Guohan Hu, Campbell, CA (US); Yinshi Liu, Foster City, CA (US); Kenneth D. Mackay, San Jose, CA (US); Vladimir Nikitin, Campbell, CA (US); James L. Nix, Gilroy, CA (US); Neil Smith, San Jose, CA (US)

Correspondence Address: PATTERSON & SHERIDAN, L.L.P., 3040 POST OAK BLVD., SUITE 1500, HOUSTON, TX, 77056, US

(73) Assignee: HITACHI GLOBAL STORAGE TECHNOLOGIES NETHERLANDS, B.V.

(21) Appl. No.: 11/244,712

(22) Filed: Oct. 6, 2005

(51) Int. Cl. G11B 5/127; G11B 5/33

(52) U.S. Cl. 360/319

(57) ABSTRACT

Methods and apparatus provide a magnetic head that includes a magnetoresistive read sensor disposed between a first magnetic shield and a second magnetic shield. The second magnetic shield is configured to reduce effects on the read sensor due to unevenness in a topography of the read sensor.

### BACKGROUND OF THE INVENTION

1. Field of the Invention

Embodiments of the invention generally relate to electronic data storage and retrieval systems having magnetic heads capable of reading recorded information stored on magnetic media.

2. Description of the Related Art

In an electronic data storage and retrieval system, a magnetic head typically includes a reader portion having a magnetoresistive (MR) sensor for retrieving magnetically-encoded information stored on a magnetic recording medium or disk. The MR sensor operates based on a change of electrical resistivity of certain materials of the MR sensor in the presence of a magnetic field. During a read operation, a bias current is passed through the MR sensor. Magnetic flux emanating from a surface of the recording medium causes rotation of a magnetization vector of a sensing layer of the MR sensor, which in turn causes the change in electrical resistivity of the MR sensor. The change in electrical resistivity of the MR sensor can be detected by measuring a voltage across the MR sensor to provide voltage information that external circuitry can then convert and manipulate as necessary.

To efficiently read data from a data track of the recording medium, the MR sensor of the magnetic head must be shielded from extraneous magnetic fields, such as those generated by adjacent data tracks, commonly known as side reading effects. Accordingly, the MR sensor is sandwiched between a pair of magnetic shields within the read head portion. During the read operation, top and bottom read shields ensure that the MR sensor reads only the information stored directly beneath it on a specific track of the recording medium by absorbing any stray magnetic fields emanating from adjacent tracks and transitions. These shields can include laminated layers of alternating ferromagnetic and nonmagnetic spacer films to ensure that the shields remain magnetically stable given that magnetostatic energy present can be sufficient to cause the shields to buckle into magnetic domains. The magnetic domains are undesirable since their exact position is uncontrolled and subject to movement during external field application, thereby having a potentially adverse effect on the read operation.

Another problem with the MR sensor is passive sensor resistance (i.e., parasitic resistance). Building up a thickness of conductor leads/hard bias layers or films of the MR sensor aides in reducing the passive sensor resistance. However, this thick build up creates a recessed section of the MR sensor proximate to an active region of the MR sensor between the conductor leads/hard bias layers. The top read shield over the MR sensor consequently conforms to a substantial uneven topography (i.e., deviation from a plane) across the MR sensor due to the recessed section. The substantial uneven topography of the MR sensor and interactions with the hard bias films causes the shield to have multiple and uncontrolled equilibrium states near the active region of the MR sensor since the micromagnetic state of the shield is uncontrolled.

The interaction of the top read shield in the recessed region with the hard bias films causes magnetic charge to accumulate, forming a local magnetic dipole just over the active region of the MR sensor. The local magnetic dipole can exhibit switching under applied field conditions. These changes in the local magnetic dipole cause significant changes in characteristics of the MR sensor. Undesired changes in the characteristics of the MR sensor can include changes in a quiescent point (bias point), changes in sensitivity and creation of magnetic noise.

Therefore, there exists a need for methods and magnetic heads that eliminate or reduce effects of a shield on a MR sensor due to unevenness in topography about an active region of the MR sensor.

### SUMMARY OF THE INVENTION

Embodiments of the invention generally relate to a magnetic head that includes a magnetoresistive read sensor disposed between a bottom magnetic shield and a top magnetic shield. The top magnetic shield is configured to reduce effects on the read sensor locally formed adjacent to an active region of the read sensor.

In one embodiment, a magnetic head includes a magnetoresistive read sensor having a recessed section proximate to an active region thereof, and a shield disposed over the magnetoresistive read sensor, wherein the shield comprises a ferromagnetic first layer, a non-magnetic second layer, a ferromagnetic third layer, and a bulk shield fourth layer, and wherein the first through third layers are disposed over a first area of the magnetoresistive read sensor that includes at least part of the recessed section, while the fourth layer is disposed over a relatively larger second area of the magnetoresistive read sensor that includes the recessed section.

In another embodiment, a method of depositing a shield adjacent a magnetoresistive read sensor includes providing the magnetoresistive read sensor having an active region, depositing in sequence a ferromagnetic first layer, a non-magnetic second layer, and a ferromagnetic third layer over the read sensor, wherein the first through third layers cover only a selected portion of the read sensor proximate to the active region, and after depositing the first through third layers, depositing a bulk shield fourth layer, wherein the fourth layer covers substantially all of the read sensor thereby covering a relatively larger area of the read sensor than the first through third layers and that includes the selected portion.

In yet another embodiment, a method of depositing a shield adjacent a magnetoresistive read sensor includes providing the magnetoresistive read sensor having an active region with a width (w) and a recessed section over the active region, wherein a depth (d) of the recessed section is such that d/w≧approximately 0.5, depositing a ferromagnetic first layer over the read sensor, wherein the depositing is performed according to a process specifically selected to provide a thickness≦d/2 for the first layer, depositing a non-magnetic second layer on the first layer, and depositing a ferromagnetic third layer on the second layer, wherein the depositing is performed according to a process specifically selected to provide a thickness>d/2 for the third layer.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a top plan view of a hard disk drive including a magnetic head, according to embodiments of the invention.

FIG. 2 is a cross-sectional diagrammatic side view of the magnetic head, according to embodiments of the invention.

FIG. 3 is a cross-sectional view of layers deposited following an initial blanket deposition for forming a first exemplary top shield, according to embodiments of the invention.

FIG. 4 is a cross-sectional view of the layers during forming of the first exemplary top shield after selective removal of a patterned region of some of the layers, according to embodiments of the invention.

FIG. 5 is a cross-sectional view of the layers while forming the first exemplary top shield subsequent to deposition of hard bias and conductor layers in the patterned region, according to embodiments of the invention.

FIG. 6 is a cross-sectional view of the layers during forming of the first exemplary top shield after deposition of a gap material on the conductor layers, according to embodiments of the invention.

FIG. 7 is a cross-sectional view of a completed magnetic head upon deposition of a bulk shield to complete the first exemplary top shield, according to embodiments of the invention.

FIG. 8 is a cross-sectional view of a read sensor formed over a bottom shield, according to embodiments of the invention.

FIG. 9 is a cross-sectional view of the read sensor with a gap material and three layers of a top shield deposited thereon, according to embodiments of the invention.

FIG. 10 is a cross-sectional view showing the three layers of the top shield during forming of a second exemplary top shield after removing a portion of the three layers, according to embodiments of the invention.

FIG. 11 is a cross-sectional view of a completed magnetic head upon deposition of a bulk shield to complete the second exemplary top shield, according to embodiments of the invention.

FIG. 12 is a cross-sectional view of a completed magnetic head upon deposition of a bulk shield to complete a third exemplary top shield by deposition of the bulk shield without removing any portion of the three layers shown in FIG. 9, according to embodiments of the invention.

FIG. 13 is a cross-sectional view of a completed magnetic head upon deposition of intermediate copper and ferromagnetic layers prior to deposition of a bulk shield to complete a fourth exemplary top shield, according to embodiments of the invention.

FIG. 14 is a graph of a transverse magnetoresistance first curve with hysteresis caused by a top shield's magnetics in comparison with a transverse magnetoresistance second curve from a sensor with a top shield according to embodiments of the invention to show substantial elimination of the hysteresis.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present in the appended claims, are not considered elements or limitations of the appended claims.

In one embodiment, laminated layers of a top magnetic shield are disposed over a recessed section of a read sensor. The laminated layers may include two ferromagnetic layers spaced apart by a non-magnetic layer that promotes Rudermann-Kittel-Kasuya-Yoshida (RKKY) type coupling when disposed between two ferromagnetic layers of appropriate band structures and thicknesses. According to some embodiments, the laminated layers can cover a relatively smaller area (e.g., only an active region of the read sensor) than a remainder of the top magnetic shield. The laminated layers in some embodiments can be planarized by chemical mechanical polishing, for example, prior to depositing a remainder of the top magnetic shield. For some embodiments, depositing the laminated layers can occur according to processes specifically selected to provide a thickness for at least one of the layers based on a depth of the recessed section.

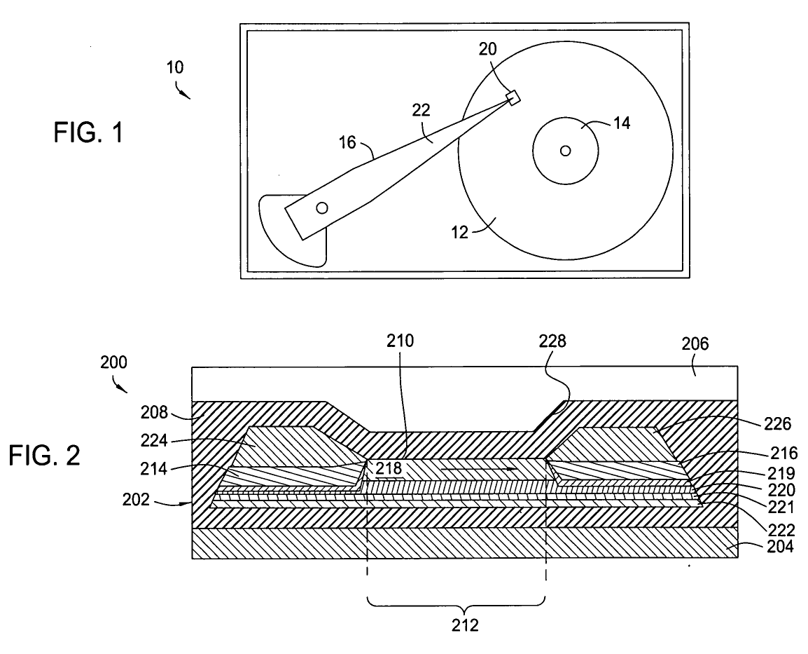

FIG. 1 illustrates a hard disk drive 10 that includes a magnetic media hard disk 12 mounted upon a motorized spindle 14. An actuator arm 16 is pivotally mounted within the hard disk drive 10 with a magnetic head 20 disposed upon a distal end 22 of the actuator arm 16. During operation of the hard disk drive 10, the hard disk 12 rotates upon the spindle 14 and the magnetic head 20 acts as an air bearing slider adapted for flying above the surface of the disk 12. As described hereinafter, the magnetic head 20 includes a substrate base upon which various layers and structures that form the magnetic head 20 are fabricated. Thus, magnetic heads disclosed herein can be fabricated in large quantities upon a substrate and subsequently sliced into discrete magnetic heads for use in devices such as the hard drive 10.

FIG. 2 shows a layered schematic diagram of a read portion of a magnetic head 200. The magnetic head 200 includes a read sensor 202 separated from a bottom shield 204 and a top shield 206 by an insulating dielectric 208. The insulating dielectric 208 is preferably a non-magnetic and non-conducting material, such as alumina (Al₂O₃). The top shield 206 is illustrated as a box representing any of the embodiments disclosed herein. A protruding area 228 of the top shield 206 corresponds to a recessed section 210 of the read sensor 202. The protruding area 228 can, but does not have to, actually have any portion thereof disposed within the recessed section 210. While the recessed section 210 is shown as a relatively discrete area, the recessed section 210 can be in the form of a valley that can extend across substantially all of the read sensor 202 with a lowest area generally along an active region 212 of the read sensor 202.

For some embodiments, the read sensor 202 is a giant magnetoresistive (GMR) sensor having a plurality of alternating magnetic and nonmagnetic layers (hereinafter “MR element stack”). For example, the MR element stack can include an antiferromagnetic layer 222, a ferromagnetic pinned layer 221, a spacer layer 220 (e.g., copper), a ferromagnetic sensing or free layer 218, and a hard bias seed layer 219. First and second hard magnetic bias layers 214, 216 provide a longitudinal magnetic bias to align the ferromagnetic free layer 218 in a single domain state. On the hard magnetic bias layers 214, 216 are disposed first and second electrode layers 224, 226 spaced apart and made of a nonmagnetic, electrically conductive material having relatively low electric resistance. The active region 212 of the read sensor 202 is located between the electrode layers 224, 226. Additionally, a thickness of the hard magnetic bias layers 214, 216 and the electrode layers 224, 226 of the read sensor 202 at least partially provide for the recessed section 210 of the read sensor 202.

As further described below and without being shown in FIG. 2, in one embodiment, the top shield 206 includes a ferromagnetic first layer, a non-magnetic second layer, a ferromagnetic third layer and a bulk shield fourth layer. In one embodiment, the bulk shield fourth layer can include laminated films and/or cover a relatively larger area than the first through third layers. The first through third layers are deposited in a manner that eliminates or reduces creation of a local magnetic dipole over the active region 212 of the read sensor 202.

First Exemplary Top Shield and Corresponding Method of Forming

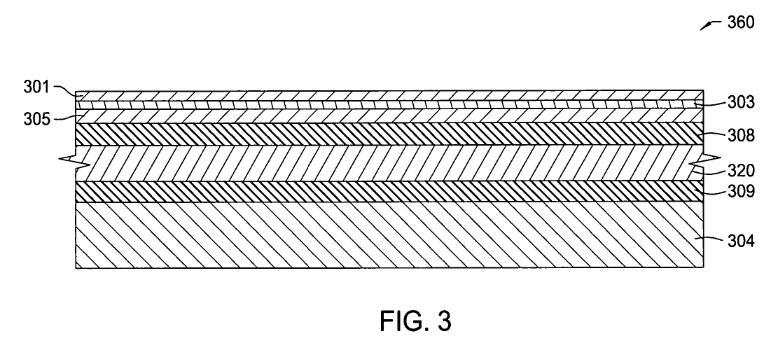

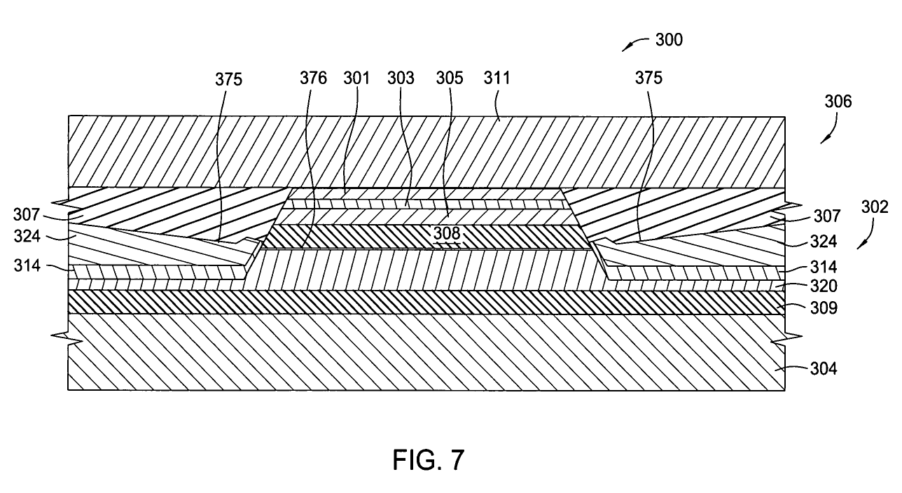

FIGS. 3 through 7 illustrate a process for forming a top shield 306 (shown in FIG. 7) according to one embodiment. FIG. 3 shows layers 360 that are all deposited by an initial blanket deposition on a substrate (not shown). The layers 360 form a bottom shield 304, a bottom gap 309, a MR element stack 320 and a top gap 308. Additionally, the layers include a top shield ferromagnetic first layer 305, a top shield non-magnetic second layer 303 and a top shield ferromagnetic third layer 301 that are sequentially deposited over the top gap 308.

For some embodiments, the top shield ferromagnetic first layer 305 includes a nickel-iron (NiFe) alloy, such as Ni_{0.8}Fe_{0.2}, which may be sputter deposited in one pumpdown. Further, the top shield non-magnetic second layer 303 can include ruthenium (Ru), or other RKKY interaction promoting material, that is sputter deposited in the same pumpdown. Additionally, the top shield ferromagnetic third layer 301 can include a NiFe alloy with properties similar to the ferromagnetic first layer 305 and can also be sputter deposited in the same pumpdown.

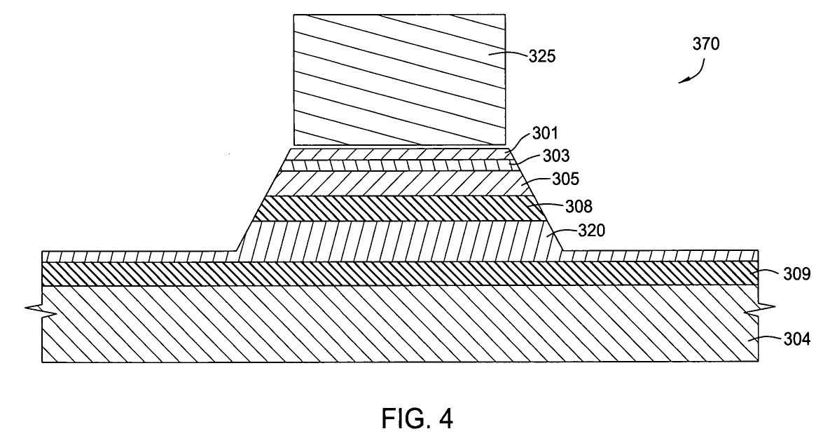

FIG. 4 shows a head precursor structure 370 after selective removal of portions of the layers 360 shown in FIG. 3 via, for example, an ion mill or ion beam etch process. In practice, a read sensor stencil 325 is formed and disposed over an area to be protected from the ion mill or ion beam etch thereby leaving a patterned region exposed. Next, milling or etching proceeds surrounding the read sensor stencil 325 in the patterned region through at least the top shield layers 301, 303, 305 and the top gap 308 to an appropriate ending point (e.g., a lower most layer of the MR element stack 320).

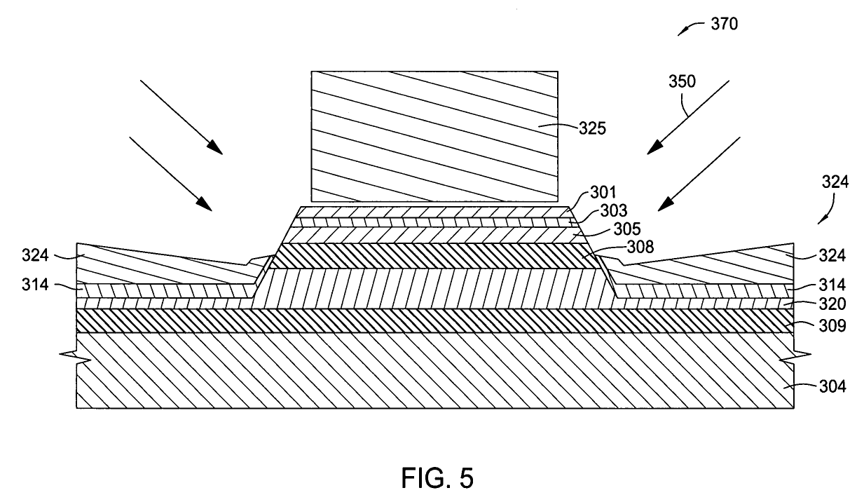

FIG. 5 illustrates a cross-sectional view of the head precursor structure 370 subsequent to deposition of hard bias layers 314 and conductor layers 324 to provide a read sensor 302. Preferably, the hard bias layers 314 and the conductor layers 324 are deposited by a directional process, such as collimated or long throw sputtering, to limit sidewall coverage of the hard bias layers 314 and the conductor layers 324 onto the top shield layers 301, 303, 305 and the top gap 308. Directional ion milling or ion beam etching (represented by arrows 350) can be utilized to clear any residue of the hard bias layers 314 and/or the conductor layers 324 from the sidewalls of the top shield layers 301, 303, 305 and/or the top gap 308 should any residue be present.

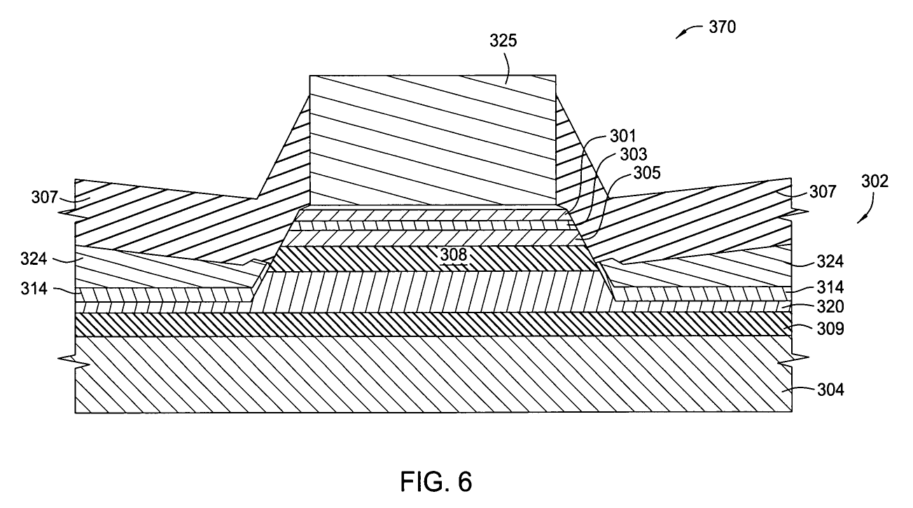

FIG. 6 shows a cross-sectional view of the head precursor structure 370 after deposition of an additional top gap material 307 on the conductor layers 324. The additional top gap material 307 abuts the top gap 308 that is already disposed between the MR element stack 320 and the top shield ferromagnetic first layer 305. Further, the additional top gap material 307 covering the conductor layers 324 can have a sufficient thickness to abut one or more of the top shield layers 301, 303, 305.

FIG. 7 is a cross-sectional view of a completed magnetic head 300 upon deposition of a bulk top shield 311. Prior to depositing the bulk top shield 311, the stencil 325 is removed to expose the top shield ferromagnetic third layer 301. Removal of the stencil 325 can be accomplished by chemical mechanical polishing (CMP) back to the top shield ferromagnetic third layer 301. Additional CMP can planarize the top shield ferromagnetic third layer 301 and/or the additional top gap material 307 to a desired level. Thereafter, depositing the bulk top shield 311 can occur by frame electroplating, for example. For some embodiments, the bulk top shield 311 can include additional laminated layers similar to the top shield layers 301, 303, 305.

The completed magnetic head 300 provides the top shield layers 301, 303, 305 over an active region of the read sensor 302. The bulk top shield 311 covers a relatively larger area than that covered by the top shield layers 301, 303, 305. Further, the bulk top shield 311 and the top shield layers 301, 303, 305 combined shield the read sensor 302 during read operations and are separated from the read sensor 302 by a combined resulting arrangement of the top gap 308 and the additional top gap material 307. Therefore, the bulk top shield 311 and the top shield layers 301, 303, 305 in combination form the top shield 306.

As shown in FIG. 7, the read sensor 302 defines a recessed section proximate to the active region thereof due to a build up and/or a downward sloping surface 375 of the conductor layers 324 toward the active region of the read sensor 302. Consequently, a top surface 376 of the MR element stack 320 along the active region generally provides the lowest area of the recessed section. The top shield layers 301, 303, 305 are therefore centered over the recessed section or valley that is defined by a topography of the read sensor 302.

As a result of antiferromagnetically coupled (AFC) coupling and the structure of the first exemplary top shield, the first ferromagnetic layer 305 next to the active region of the read sensor 302 has a micromagnetic state that is more magnetically stable to reduce the formation of local magnetic dipoles. Consequently, the top shield 306 has little influence on a free layer of the MR element stack 320 in the presence of applied magnetic fields, thereby improving performance of the read sensor 302. The second and third exemplary top shields discussed below are similarly believed to benefit from AFC coupling.

Second Exemplary Top Shield and Corresponding Method of Forming

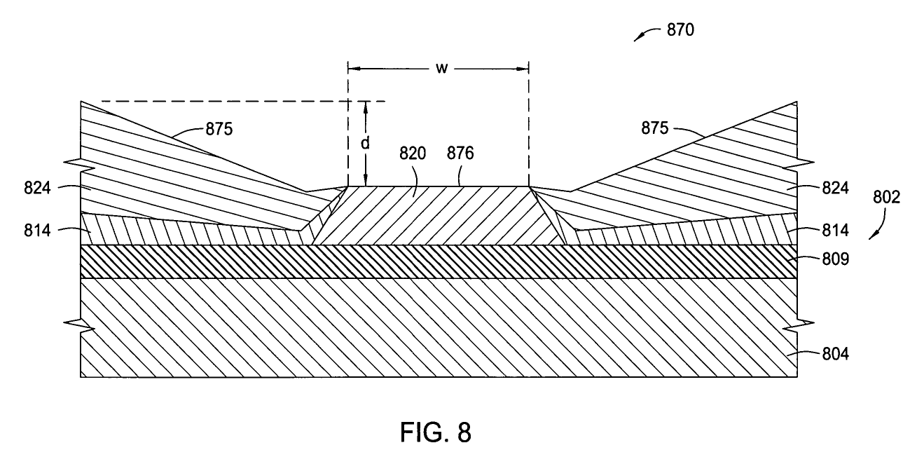

FIG. 8 illustrates a cross-sectional view of a head precursor structure 870 that includes a read sensor 802 formed over a bottom gap 809 and a bottom shield 804. In practice, any conventional methods for forming the head precursor structure 870 or alternate configurations of the read sensor 802 can be utilized, as various such structures are produced commercially. The read sensor 802 includes a MR element stack 820 having an active region with a width (w) between spaced apart hard bias layers 814 and conductor layers 824 disposed on the hard bias layers 814.

The read sensor 802 defines a recessed section proximate to the active region thereof due to a build up and/or a downward sloping surface 875 of the conductor layers 824 toward the active region of the read sensor 802. A top surface 876 of the MR element stack 820 along the active region generally provides the lowest area of the recessed section. Accordingly, a depth (d) of the recessed section is defined as a vertical distance from the top surface 876 of the MR element stack 820 to a height that is a maximum height of the read sensor 802 either within a predetermined area surrounding the active region or an entire area of the read sensor 802. For some embodiments, the depth d of the recessed section is measured relative to the maximum height of the read sensor 802 within three times w away from a center of the active region.

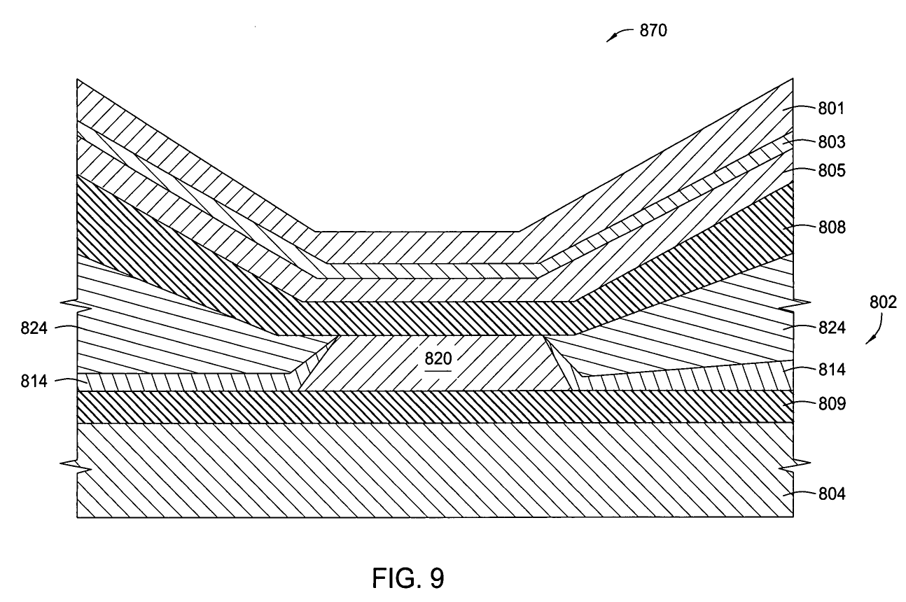

FIG. 9 shows a cross-sectional view of the head precursor structure 870 upon sequentially blanket depositing a top gap 808, a top shield ferromagnetic first layer 805, a top shield non-magnetic second layer 803 and a top shield ferromagnetic third layer 801 over the read sensor 802. For some embodiments, the top shield layers 801, 803, 805 are similar in composition and are deposited in a similar manner as described above regarding corresponding layers of the first exemplary top shield. The gap material 808 and the top shield layers 801, 803, 805 conform to the recessed section of the read sensor 802.

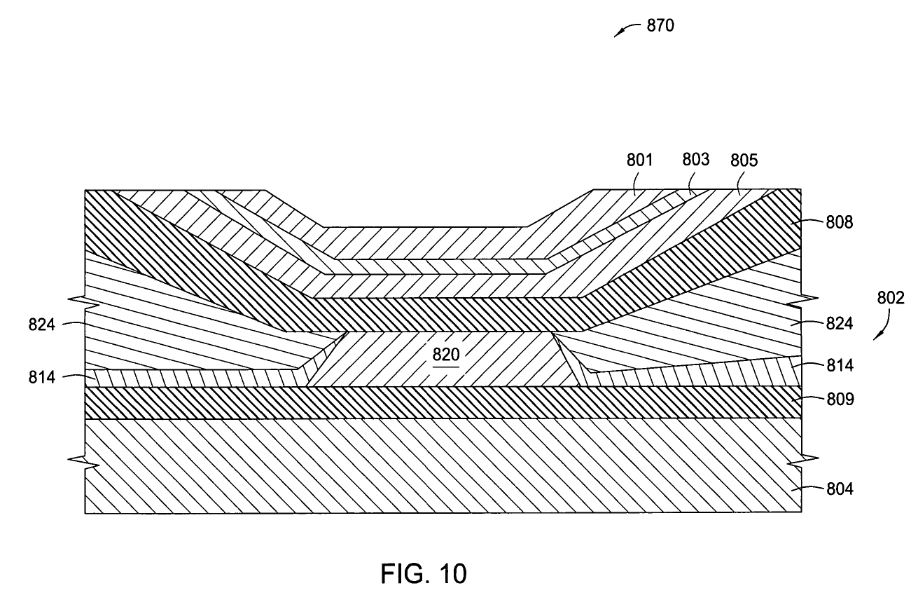

FIG. 10 illustrates a cross-sectional view of the head precursor structure 870 after removing a portion of one or more of the top shield layers 801, 803, 805 and optionally a portion of the top gap 808. This removing of material can be accomplished by CMP. Thus, the CMP planarizes the head precursor structure 870 to a desired level. Upon performing the CMP, one or more of the top shield layers 801, 803, 805 can cover a smaller area over the read sensor 802 since the top shield layers 801, 803, 805 conformed to the recessed section of the read sensor 802 during deposition. Further, the top shield layers 801, 803, 805 are consequently disposed over a portion of the read sensor 802 that includes the recessed section proximate the active region of the read sensor 802 and have an outer shape corresponding to substantially only a shape of the recessed section.

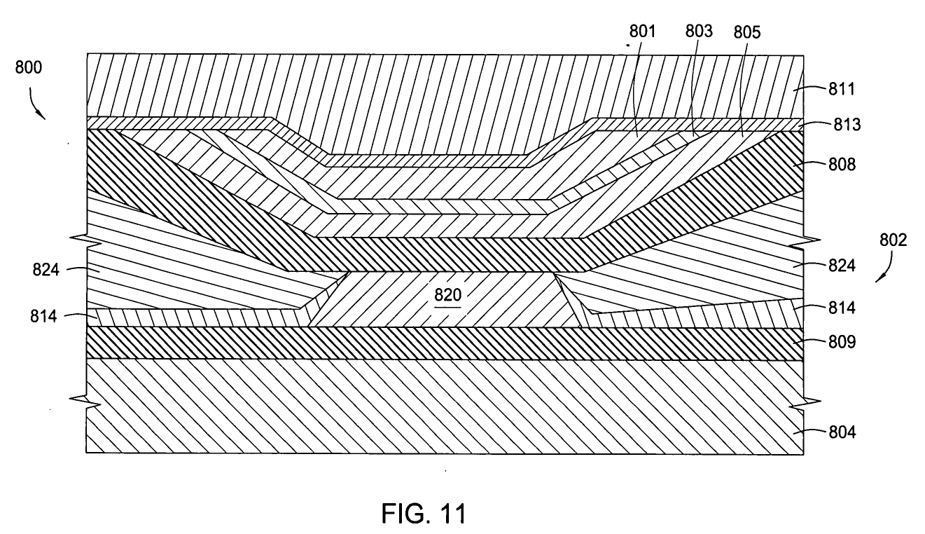

FIG. 11 shows a cross-sectional view of a completed magnetic head 800 upon deposition of a bulk top shield 811. The bulk top shield 811 and the top shield layers 801, 803, 805 combined shield the read sensor 802 during read operations. Structure of the top shield layers 801, 803, 805 and AFC coupling between the top shield layers 801, 803, 805 substantially prevents formation of a local magnetic dipole over the active region of the read sensor 802.

For some embodiments, the completed magnetic head 800 can include an optional intermediate layer 813 deposited prior to the bulk top shield 811 to avoid ferromagnetic exchange coupling between the top shield layers 801, 803, 805 and the bulk top shield 811. The intermediate layer 813 can be an insulator or non-magnetic metal layer such as alumina, tantalum (Ta), or ruthenium (Ru). When present, the intermediate layer 813 can have a thickness of between about 1.0 nm and 100 nm.

Third Exemplary Top Shield and Corresponding Method of Forming

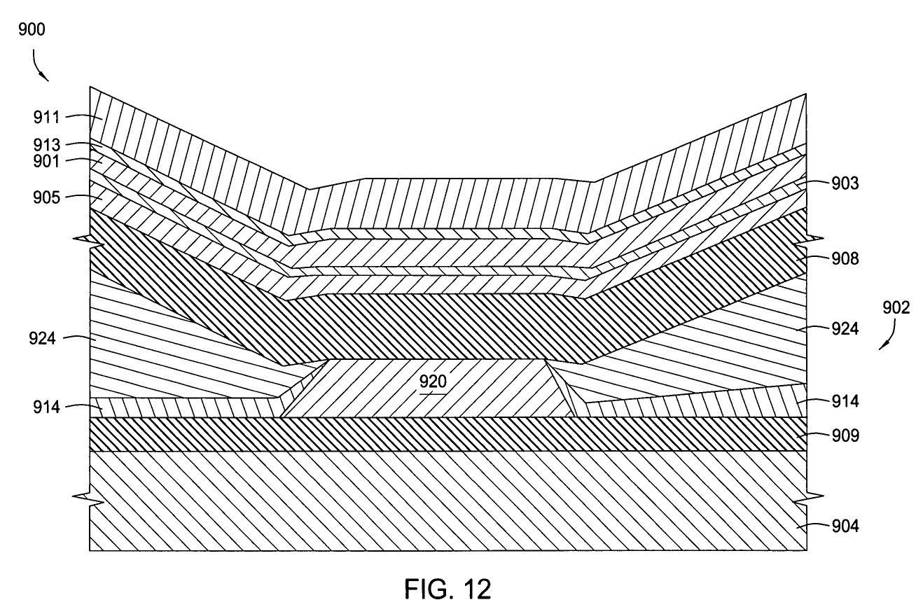

FIG. 12 illustrates a cross-sectional view of a completed magnetic head 900 upon deposition of a bulk top shield 911 to complete a third exemplary top shield by deposition of the bulk top shield 911 following deposition of a top shield ferromagnetic first layer 905, a top shield non-magnetic second layer 903 and a top shield ferromagnetic third layer 901 without removing any of the top shield layers 901, 903, 905. Initially, a read sensor 902 is formed over a bottom gap 909 and a bottom shield 904 and includes a MR element stack 920 and hard bias layers 914 and conductor layers 924, such as shown in FIG. 8. Next, sequentially blanket depositing a top gap 908, the top shield ferromagnetic first layer 905, the top shield non-magnetic second layer 903 and the top shield ferromagnetic third layer 901 over the read sensor 902 provides a structure such as the precursor head structure 870 shown in FIG. 9. The gap material 908 and the top shield layers 901, 903, 905 conform to a recessed section of the read sensor 902. Depositing the top shield layers 901, 903, 905 is performed according to a process specifically selected based on structural features of the read sensor 902.

With reference to FIG. 8, the read sensor 902 includes an active region with a width (w) and a recessed section over the active region. A depth (d) of the recessed section is such that a ratio of the depth to the width (d/w) is greater than or equal to approximately 0.5. Depositing the ferromagnetic first layer 905 over the read sensor 902 is performed according to a process specifically selected to provide a thickness less than or equal to half the depth (d/2) for the ferromagnetic first layer 905. Depositing the non-magnetic second layer 903 on the first layer can be selected to provide a thickness between 0.2 nanometers (nm) and 2.0 nm for the non-magnetic second layer 903. Depositing the ferromagnetic third layer 901 on the non-magnetic second layer 903 is performed according to a process specifically selected to provide a thickness greater than half the depth for the ferromagnetic third layer 901. For some embodiments, the top shield layers 901, 903, 905 are similar in composition and are deposited in a similar manner as described above regarding corresponding layers of the first exemplary top shield.

After depositing the top shield layers 901, 903, 905 with these recited processes, the bulk top shield 911 is deposited in a conformal deposition onto the ferromagnetic third layer 901. Like other embodiments disclosed, the bulk top shield 911 and the top shield layers 901, 903, 905 combined shield the read sensor 902 during read operations. When the recited processes are utilized, the top shield layers 901, 903, 905 substantially prevent formation of a local magnetic dipole over the active region of the read sensor 902. Additionally, depositing for any of the other embodiments disclosed herein can be performed according to a process specifically selected to provide the foregoing layer thicknesses.

For some embodiments, the completed magnetic head 900 can include an optional intermediate layer 913 deposited prior to the bulk top shield 911. The intermediate layer 913 can be disposed between the top shield ferromagnetic third layer 901 and the bulk top shield 911 to promote ferromagnetic coupling therebetween. Further, the intermediate layer 913 can be a non-magnetic metal such as copper (Cu). When present, the thickness of the intermediate layer 913 can be about 3 nm or less.

Fourth Exemplary Top Shield and Corresponding Method of Forming

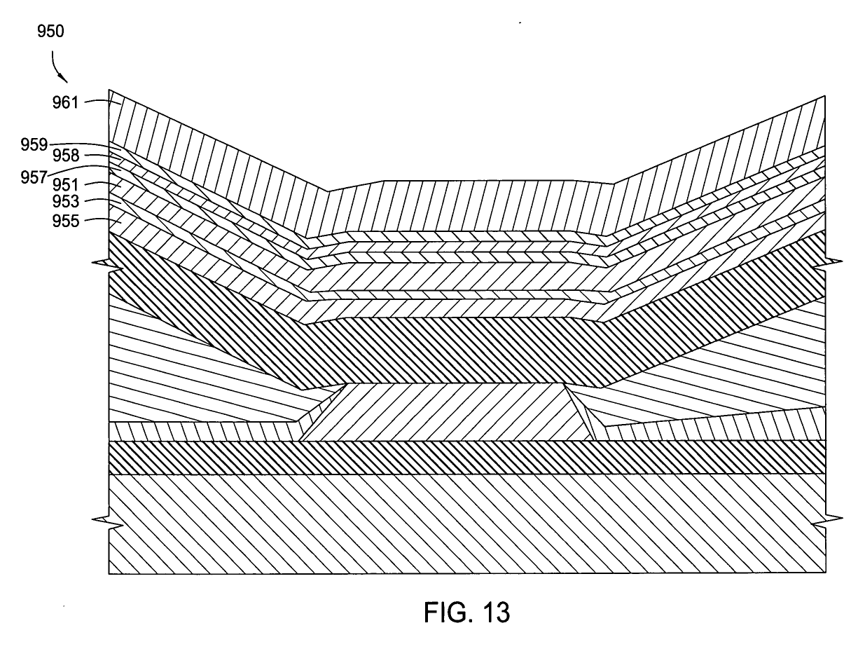

FIG. 13 illustrates a completed magnetic head 950 according to another embodiment. A top shield ferromagnetic first layer 955, a top shield non-magnetic second layer 953 and a top shield ferromagnetic third layer 951 are deposited to provide a structure such as the precursor head structure 870 shown in FIG. 9. For some embodiments the top shield non-magnetic second layer 953 comprises copper. Without removing any of the top shield layers 951, 953, 955, a first intermediate Cu layer 957 is deposited over the top shield ferromagnetic third layer 951 followed by an intermediate ferromagnetic layer 958 and a second intermediate Cu layer 959. Accordingly, the intermediate Cu and ferromagnetic layers 957, 958, 959 are disposed between top shield ferromagnetic third layer 951 and a bulk top shield 961 that is subsequently deposited. For some embodiments, any number of additional layers of the intermediate Cu and ferromagnetic layers 957, 958, 959 can provide a plurality of intermediate ferromagnetic layers laminated with intermediate Cu layers. Each of the individual ferromagnetic layers such as the intermediate ferromagnetic layer 958 can be a NiFe alloy and can have a thickness of between about 10 nm and 100 nm. Each of the intermediate Cu layers such as the intermediate Cu layers 957, 959 can have a thickness of about 3 nm or less.

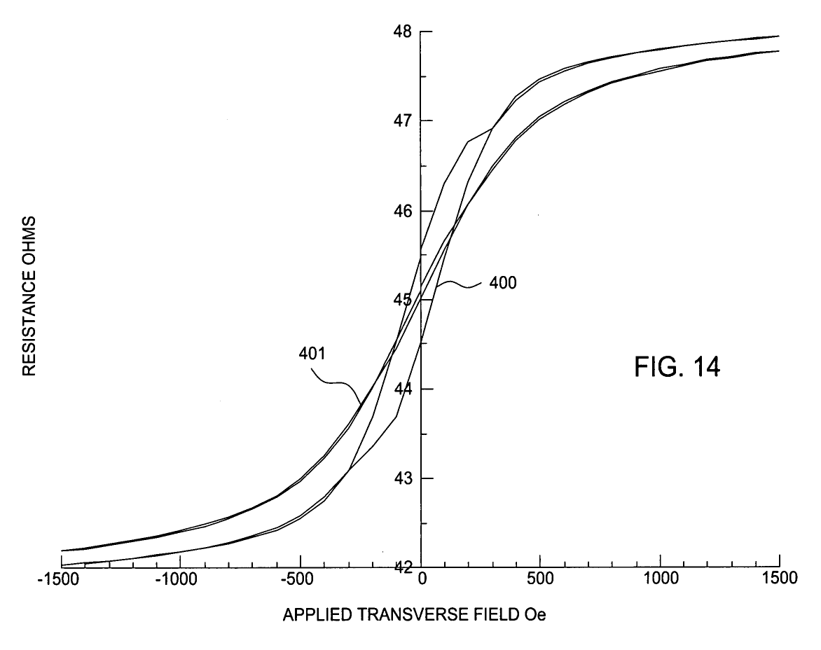

FIG. 14 illustrates a graph of a transverse magnetoresistance first curve 400 with hysteresis caused by a top shield's magnetics in comparison with a transverse magnetoresistance second curve 401 from a sensor with a top shield according to embodiments of the invention. In the first curve, multiple resistance values undesirably exist for a given applied field due to top shield micromagnetic effects influencing the sensor. In contrast, the second curve 401 shows substantial elimination of the hysteresis.

Terms of orientation, such as top, bottom, over, under, above, below and side are used herein. These terms are intended to be relative terms used for purposes of illustration. Other orientations are contemplated and will be appreciated by those skilled in the art informed by the present disclosure.

While the foregoing is directed to embodiments of the present invention, other and further embodiments of the invention may be devised without departing from the basic scope thereof, and the scope thereof is determined by the claims that follow.

What is claimed is:

1. A magnetic head, comprising:
a magnetoresistive read sensor forming a recessed section proximate to an active region thereof; and
a shield disposed over the magnetoresistive read sensor, wherein the shield comprises a ferromagnetic first layer, a non-magnetic second layer, a ferromagnetic third layer, and a bulk shield fourth layer;
wherein the first through third layers are disposed over a first area of the magnetoresistive read sensor that includes at least part of the recessed section, while the fourth layer is disposed over a relatively larger second area of the magnetoresistive read sensor that includes the recessed section.

2. The magnetic head of claim 1, wherein the first through fourth layers are arranged respectively further away from the magnetoresistive read sensor.

3. The magnetic head of claim 1, wherein the first through third layers are disposed over substantially only the active region of the magnetoresistive read sensor.

4. The magnetic head of claim 1, wherein an outer shape of the first through third layers corresponds to substantially only a volume within the recessed section.

5. The magnetic head of claim 1, further comprising first and second spaced apart conductor and hard bias layers of the read sensor, wherein the recessed region is generally defined by an area between the first and second spaced apart conductor and hard bias layers.

6. The magnetic head of claim 1, wherein the non-magnetic second layer comprises ruthenium.

7. The magnetic head of claim 1, wherein the non-magnetic second layer comprises ruthenium and has a thickness between about 0.2 nanometers (nm) and about 2.0 nm.

8. The magnetic head of claim 1, wherein the ferromagnetic first and third layers comprise an alloy including iron and nickel.

9. The magnetic head of claim 1, wherein the non-magnetic second layer comprises ruthenium and the ferromagnetic first and third layers comprise an alloy including iron and nickel.

10. A method of depositing a shield adjacent a magnetoresistive read sensor, comprising:
providing the magnetoresistive read sensor having an active region;
depositing in sequence a ferromagnetic first layer, a non-magnetic second layer, and a ferromagnetic third layer over the read sensor, wherein the first through third layers cover only a selected portion of the read sensor proximate to the active region; and
after depositing the first through third layers, depositing a bulk shield fourth layer,
wherein the fourth layer covers substantially all of the read sensor thereby covering a relatively larger area of the read sensor than the first through third layers and that includes the selected portion.

11. The method of claim 10, further comprising:
removing a portion of the first through third layers to form a patterned region; and then
depositing first and second spaced apart conductor and hard bias layers of the read sensor in the patterned region to form a recessed section of the magnetoresistive read sensor substantially under the first through third layers.

12. The method of claim 10, further comprising planarizing one or more of the first through third layers such that an outer shape of the first through third layers substantially only fills a recessed section of the magnetoresistive read sensor.

13. The method of claim 10, further comprising:
prior to depositing the first through third layers, depositing first and second spaced apart conductor and hard bias layers of the read sensor to form a recessed section, wherein at least a portion of the subsequently deposited first through third layers is deposited over the recessed section; and
planarizing the first through third layers.

14. The method of claim 10, further comprising depositing an intermediate layer prior to depositing the bulk shield fourth layer, wherein the intermediate layer prevents ferromagnetic exchange coupling between the fourth layer and at least one of the first through third layers.

15. A method of depositing a shield adjacent a magnetoresistive read sensor, comprising:
providing the magnetoresistive read sensor having an active region with a width (w) and a recessed section over the active region, wherein a depth (d) of the recessed section is such that d/w≧approximately 0.5;
depositing a ferromagnetic first layer over the read sensor, wherein the depositing is performed according to a process specifically selected to provide a thickness≦d/2 for the first layer;
depositing a non-magnetic second layer on the first layer; and
depositing a ferromagnetic third layer on the second layer, wherein the depositing is performed according to a process specifically selected to provide a thickness>d/2 for the third layer.

16. The method of claim 15, further comprising depositing a bulk shield fourth layer over an area of the magnetoresistive read sensor covering a relatively larger area than the first through third layers that the fourth layer is deposited over.

17. The method of claim 15, further comprising:
removing a portion of the first through third layers to form a patterned region; and then
depositing first and second spaced apart conductor and hard bias layers of the read sensor in the patterned region to form the recessed section substantially under the first through third layers.

18. The method of claim 15, further comprising:
prior to depositing the first through third layers, depositing first and second spaced apart conductor and hard bias layers of the read sensor to form the recessed section, wherein at least a portion of the subsequently deposited first through third layers is deposited over the recessed section; and
planarizing the first through third layers.

19. The method of claim 15, wherein the depositing of the non-magnetic second layer is performed according to a process specifically selected to provide a thickness between about 0.2 nanometers (nm) and about 2.0 nm for the second layer.

20. The method of claim 15, wherein the depth of the recessed section is measured relative to a maximum height of the read sensor within three times w away from a center of the active region.

21. The method of claim 15, further comprising removing a portion of the first through third layers such that the first through third layers are disposed over substantially only the active region of the magnetoresistive read sensor.

22. The method of claim 15, further comprising depositing an intermediate non-magnetic layer disposed between the ferromagnetic third layer and a bulk shield fourth layer, wherein the intermediate non-magnetic layer promotes ferromagnetic coupling between the ferromagnetic third layer and the bulk shield fourth layer.

23. The method of claim 15, further comprising depositing a first intermediate copper layer, an intermediate ferromagnetic layer and a second intermediate copper layer, wherein the intermediate copper and ferromagnetic layers are disposed between the ferromagnetic third layer and a bulk shield fourth layer.

24. A magnetic head, comprising:
a magnetic resistive sensor means for reading data from a magnetic storage medium, the sensor means forming a recessed section proximate to an active region thereof; and
a shield means for magnetically shielding the sensor means, wherein the shield means comprises:
a first ferromagnetic means;
a non-magnetic means;
a second ferromagnetic means; and
a bulk shield means, wherein the bulk shield means is disposed over a relatively larger area of the sensor means than the first and second ferromagnetic means and the non-magnetic means that are disposed over a portion of the sensor means that includes at least part of the recessed section.

25. A magnetic head, comprising:
a magnetic resistive sensor for reading data from a magnetic storage medium, the sensor forming a recessed section proximate to an active region thereof; and
a shield for magnetically shielding the sensor, wherein the shield comprises:
a first nickel-iron alloy layer disposed over a section of the sensor, wherein a thickness of the first nickel-iron alloy layer is less than half a depth of the recessed section;
a ruthenium layer disposed on the first nickel-iron alloy layer, wherein a thickness of the ruthenium layer is between about 0.2 nanometers (nm) and about 2.0 nm;
a second nickel-iron alloy layer disposed on the ruthenium layer wherein a thickness of the second nickel-iron alloy layer is greater than half the depth of the recessed section; and
a bulk shield disposed on the second ferromagnetic layer, wherein the bulk shield is disposed over a relatively larger area of the sensor than the first and second nickel-iron alloy layers and the ruthenium layer that are disposed over substantially only the recessed section.

26. The magnetic head of claim 25, wherein the nickel-iron alloy layers are Ni_{0.8}Fe₂.

27. The magnetic head of claim 25, further comprising an intermediate non-magnetic layer disposed between the second nickel-iron alloy layer and the bulk shield, wherein the intermediate non-magnetic layer promotes ferromagnetic coupling between the second nickel-iron alloy layer and the bulk shield.

28. The magnetic head of claim 25, further comprising a first intermediate copper layer, an intermediate ferromagnetic layer and a second intermediate copper layer, wherein the intermediate copper and ferromagnetic layers are disposed between the second nickel-iron alloy layer and the bulk shield.
